(19) United States
(12) Patent Application Publication
(10) Pub. No.: US 2011/0227269 A1
(43) Pub. Date: Sep. 22, 2011

(54) Replaceable jaw carriers of bar clamp with adaptable jaws

(76) Inventor: Bo Ren Zheng, Taichung (TW)

(21) Appl. No.: 12/728,274

(22) Filed: Mar. 22, 2010

(51) Int. Cl. B25B 5/16

(52) U.S. Cl. 269/285

(57) ABSTRACT

A bar clamp includes a slide bar; a housing mounted on the slide bar; a rear handgrip extending from the housing; a forward trigger handle extending from the housing, a sliding block releasably mounted on the slide bar in front of the housing; a fixed jaw carrier having an adaptable first jaw at one end; a moveable jaw carrier having an adaptable second jaw at one end; a first coupling mechanism for releasably securing the housing to the fixed jaw carrier; and a second coupling mechanism for releasably securing the sliding block to the moveable jaw carrier.

### BACKGROUND OF THE INVENTION

1. Field of Invention

The invention relates to bar clamps and more particularly to a bar clamp having two replaceable jaw carriers each having an adaptable jaw.

2. Description of Related Art

A typical bar clamp is shown in FIG. 1 and comprises a fixed jaw carrier 1 having a jaw 4, a moveable jaw carrier 2 having a jaw 4, a slide bar 3, a housing 5 mounted on the slide bar 3, a rear handgrip 6 extending from the housing 5, a forward trigger handle 7 extending from the housing 5, and a sliding block 8 releasably mounted on a front end of the slide bar 3.

However, the jaw carriers 1, 2 are not replaceable. This means that it is impossible of replacing the jaw carrier if it is damaged. Further, the jaws 4 are capable of clamping a work piece having two opposite flat surfaces only. In short, the jaws 4 are not adaptable to work pieces of different shapes.

A type of bar clamp with replaceable jaws is commercially available. However, it is not durable. Moreover, its jaws are not adapted to clamp work pieces of different shapes. Thus, the need remains for a bar clamp with replaceable jaw carriers each having an adaptable jaw.

### SUMMARY OF THE INVENTION

It is therefore one object of the invention to provide a bar clamp comprising a slide bar; a housing mounted on the slide bar; a rear handgrip extending from the housing; a forward trigger handle extending from the housing, a sliding block releasably mounted on the slide bar in front of the housing; a fixed jaw carrier having an adaptable first jaw at one end; a moveable jaw carrier having an adaptable second jaw at one end; a first coupling mechanism for releasably securing the housing to the fixed jaw carrier; and a second coupling mechanism for releasably securing the sliding block to the moveable jaw carrier.

The above and other objects, features and advantages of the invention will become apparent from the following detailed description taken with the accompanying drawings.

### BRIEF DESCRIPTION OF THE DRAWINGS

FIG. 1 is a side elevation of a typical bar clamp;

FIG. 2 is a side elevation of a bar clamp according to the invention;

FIG. 3 is an exploded view of FIG. 2;

FIG. 4A is a view taken from the arrow A of FIG. 3;

FIG. 4B is a view taken from the arrow A′ of FIG. 3;

FIG. 5A is a sectional view taken from line 5-5 of FIG. 3;

FIG. 5B is a sectional view taken from line 5′-5′ of FIG. 3;

FIG. 6 is a view similar to FIG. 2 showing the fastening of the coupling section;

FIG. 7 is a sectional view taken along line 7-7 of FIG. 6;

FIGS. 8 and 9 are side elevation and top view of either jaw respectively according to a first preferred embodiment of the invention;

FIG. 10 is a view taken from the arrow B of FIG. 9;

FIG. 11 is a view similar to FIG. 9 showing a pivotal movement of jaw components;

FIGS. 12 and 13 are side elevation and top view of two jaws according to a second preferred embodiment of the invention respectively;

FIGS. 14 and 15 are side elevation and top view of a third jaw according to the second preferred embodiment of the invention respectively;

FIG. 16 is a top view showing a clamping operation of the two jaws of FIGS. 13 and 15;

FIG. 17 is a side elevation in part section of one of a pair of jaws according to a third preferred embodiment of the invention;

FIG. 18 is a cross-sectional view of FIG. 17;

FIG. 19 is a view taken from the arrow C of FIG. 18;

FIG. 20 is a side elevation in part section of one of a pair of jaws according to a fourth preferred embodiment of the invention;

FIG. 21 is a front view of FIG. 20;

FIG. 22 is a fragmentary view of FIG. 21 showing a work piece to be clamped;

FIG. 23 is a front view of the upper portion of either coupling section according to another preferred embodiment thereof;

FIG. 24 is a sectional view the lower portion of either coupling section according to another preferred embodiment thereof; and

FIG. 25 is a sectional view showing a mating engagement of the upper and lower portions of either coupling section shown in FIGS. 23 and 24.

### DETAILED DESCRIPTION OF THE INVENTION

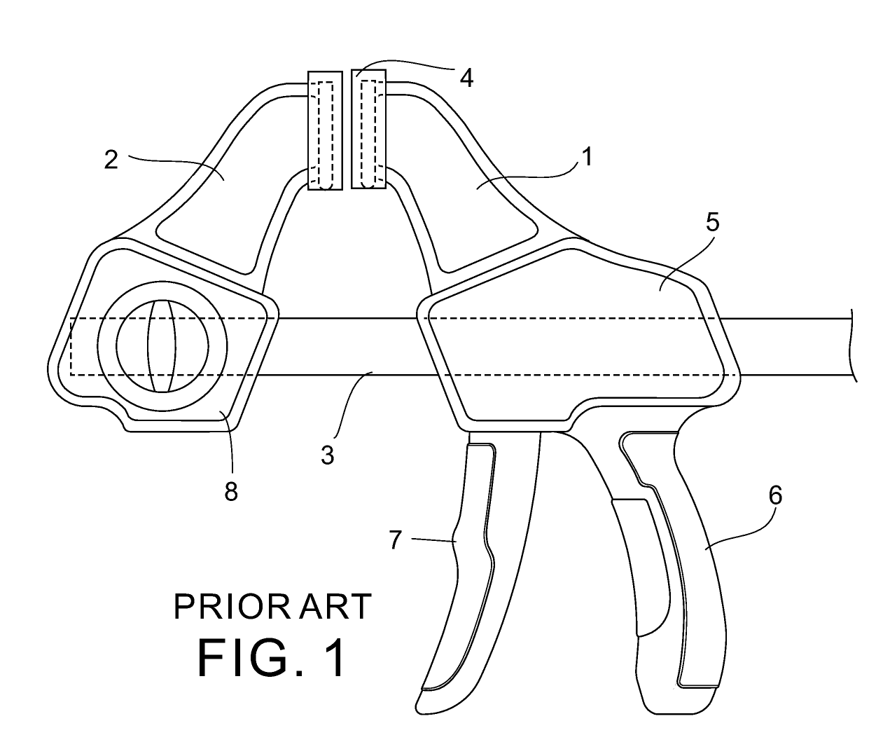

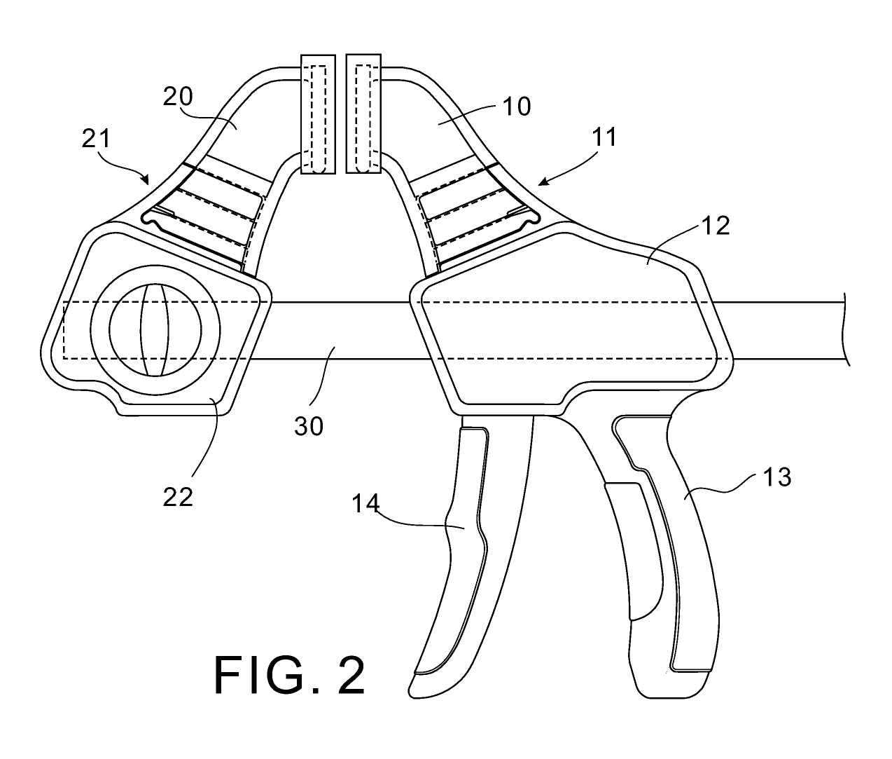

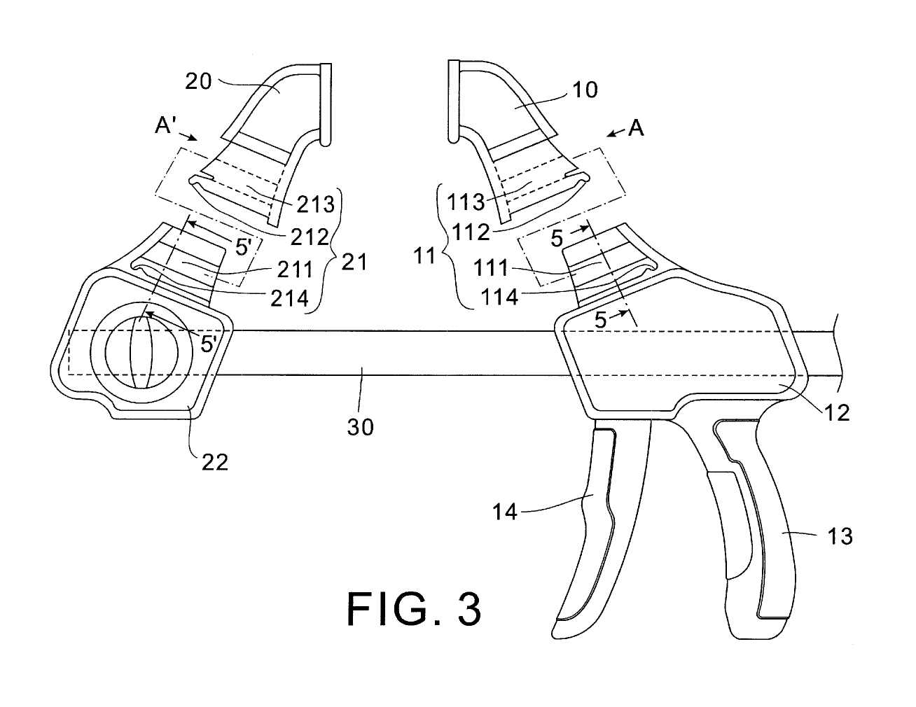

Referring to FIGS. 1 to 25, a bar clamp in accordance with the invention comprises a fixed jaw carrier 10 having a jaw 40, 50, 60, or 70, a moveable jaw carrier 20 having an adaptable jaw 40, 50, 60, or 70, a slide bar 30, a housing 12 mounted on the slide bar 30, a rear handgrip 13 extending from the housing 12, a forward trigger handle 14 extending from the housing 12, and a sliding block 22 releasably mounted on a front end of the slide bar 30.

The fixed jaw carrier 10 comprises a coupling section 11 including a lower projection 112 and an upper groove 113 both formed on a portion depending downward from the fixed jaw carrier 10. The coupling section 11 further comprises an upper projection 111 and a lower groove 114 both formed on a portion depending upward from the housing 12. The projection 112 is adapted to matingly engage with the complementary groove 114 and the projection 111 is adapted to matingly engage with the complementary groove 113 to releasably secure the fixed jaw carrier 10 and the housing 12 together.

The moveable jaw carrier 20 comprises a coupling section 21 including a lower projection 212 and an upper groove 213 both formed on a portion depending downward from the moveable jaw carrier 20. The coupling section 21 further comprises an upper projection 211 and a lower groove 214 both formed on a portion depending upward from the sliding block 22. The projection 212 is adapted to matingly engage with the complementary groove 214 and the projection 211 is adapted to matingly engage with the complementary groove 213 to releasably secure the moveable jaw carrier 20 and the sliding block 22 together.

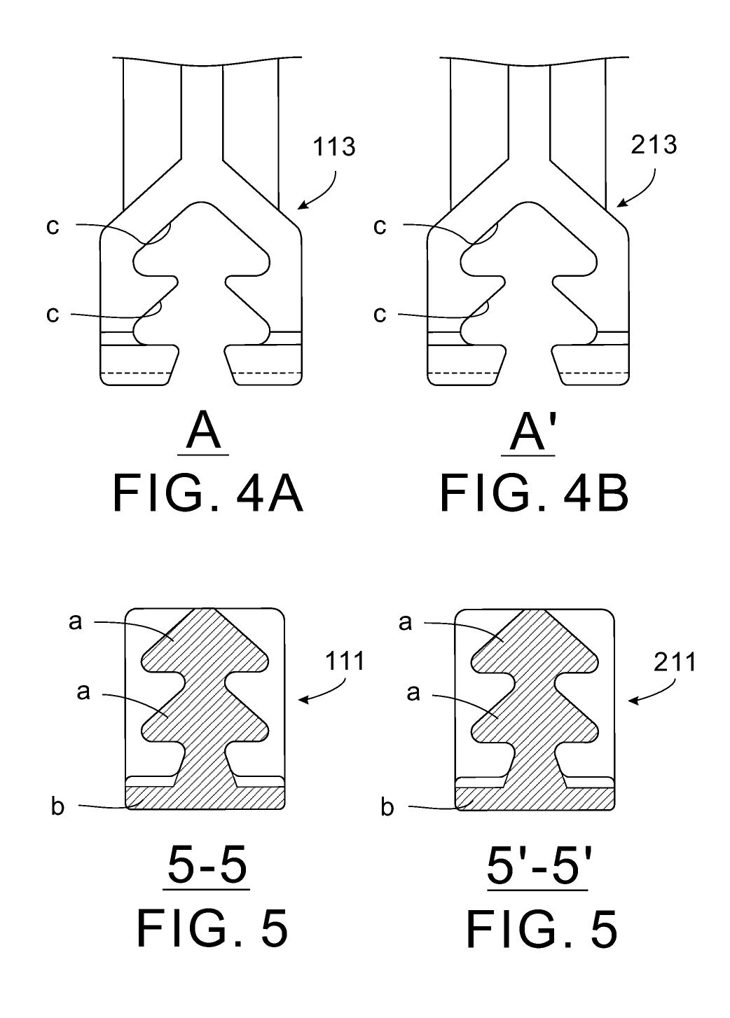

Referring to FIG. 4A, the portion of the coupling section 11 depending downward from the fixed jaw carrier 10 is shown. An upper groove c of triangular section communicates with a lower groove c of triangular section.

Referring to FIG. 4B, the portion of the coupling section 21 depending downward from the moveable jaw carrier 20 is shown. An upper groove c of triangular section communicates with a lower groove c of triangular section.

Referring to FIG. 5A, the portion of the coupling section 11 depending upward from the housing 12 is shown. An upper projection a of triangular section communicates with a lower projection a of triangular section which is in turn formed with a base b.

Referring to FIG. 5B, the portion of the coupling section 21 depending upward from the sliding block 22 is shown. An upper projection a of triangular section communicates with a lower projection a of triangular section which is in turn formed with a base b.

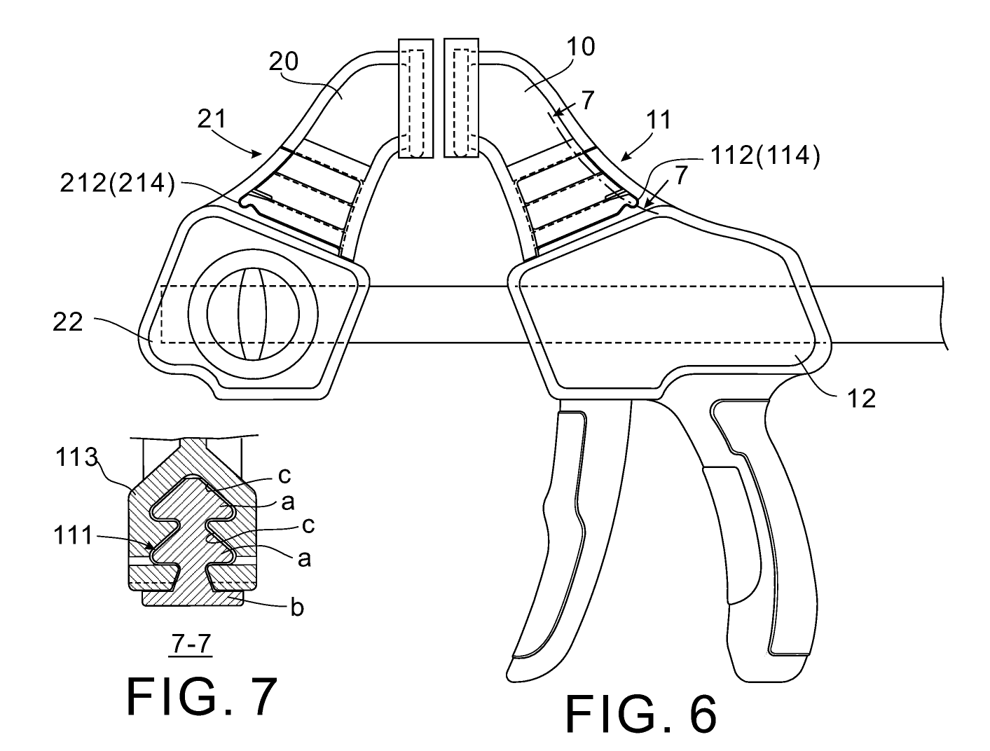

Referring to FIGS. 6 and 7, it is shown that two separate portions of the coupling section 11 are matingly engaged together and two separate portions of the coupling section 21 are matingly engaged together respectively.

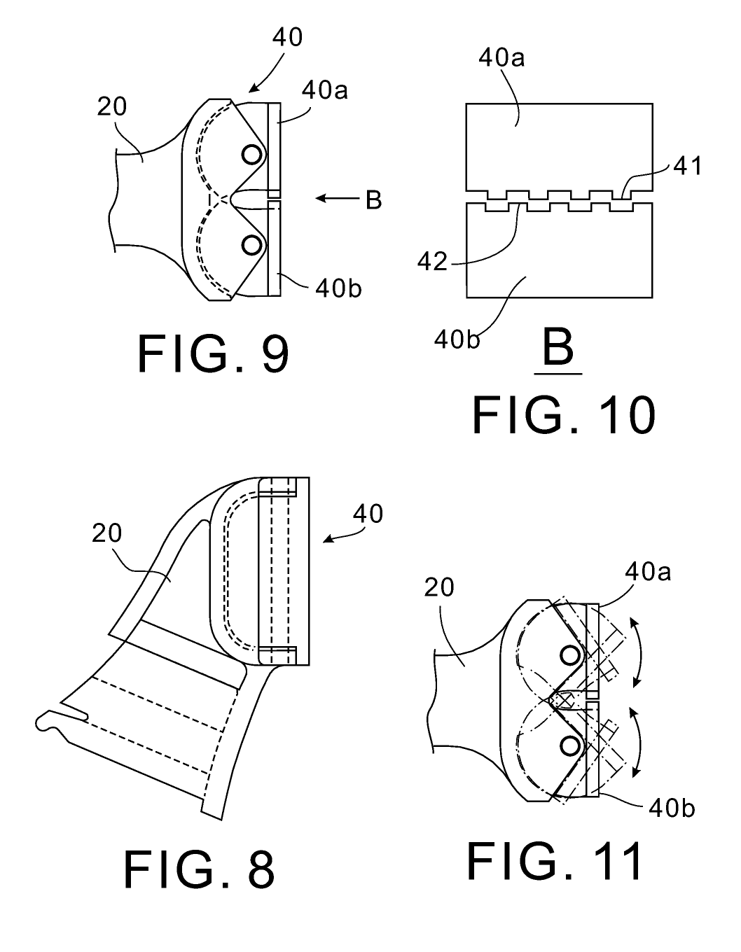

Referring to FIGS. 8 to 11, one of a pair of jaws 40 according to a first preferred embodiment of the invention is shown. The jaw 40, for example formed on the moveable jaw carrier 20, comprises a pivotal upper rectangular portion 40a having a plurality of rectangular teeth 41 on its lower edge, and a pivotal lower rectangular portion 40b having a plurality of rectangular teeth 42 on its upper edge, the teeth 42 being complementary to the teeth 41 and spaced therefrom by a sufficient predetermined distance so as not to interfere with the teeth 41 in pivotal movement. The other jaw 40 is identical to the jaw 40 described above except being formed on the fixed jaw carrier.

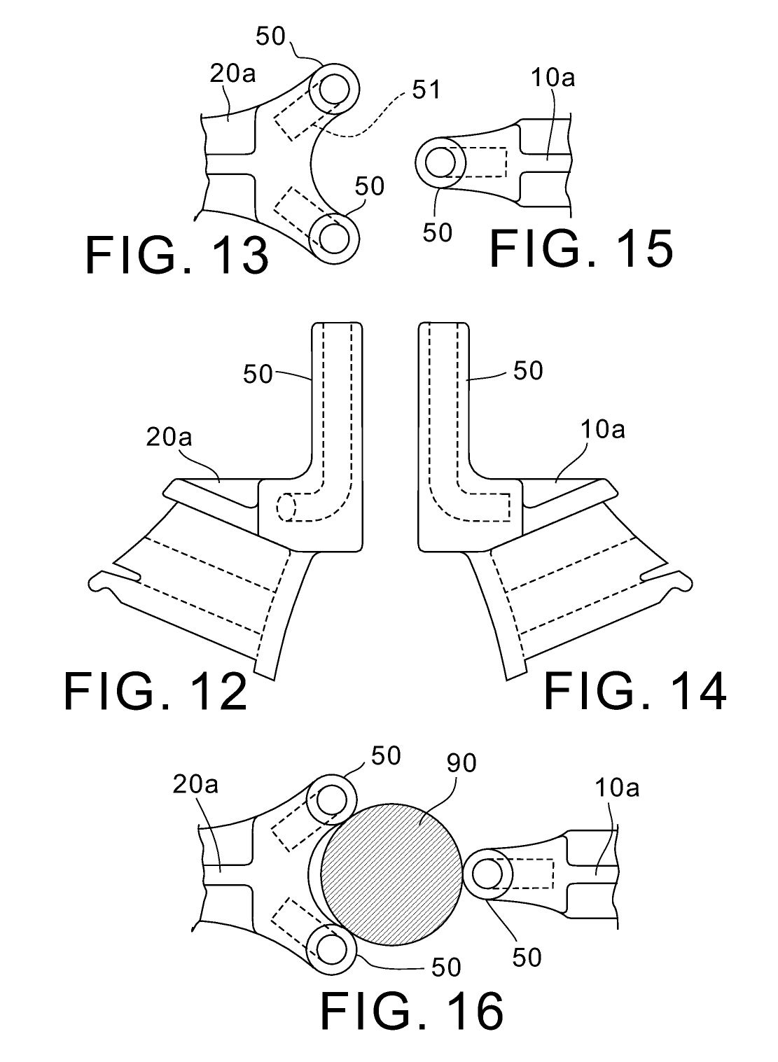

Referring to FIGS. 12 to 16, three jaws 50 according to a second preferred embodiment of the invention are shown. Two post shaped jaws 50 are splayed and are formed on the moveable jaw carrier 20a and a third post shaped jaw 50 is formed on the fixed jaw carrier 10a. The three jaws 50 are arranged as three corners of a triangle. Each jaw 50 has a bent reinforced metal member 51 formed therein for increasing the structural strength. In operation, a work piece 90 of circular section can be clamped by the three jaws 50.

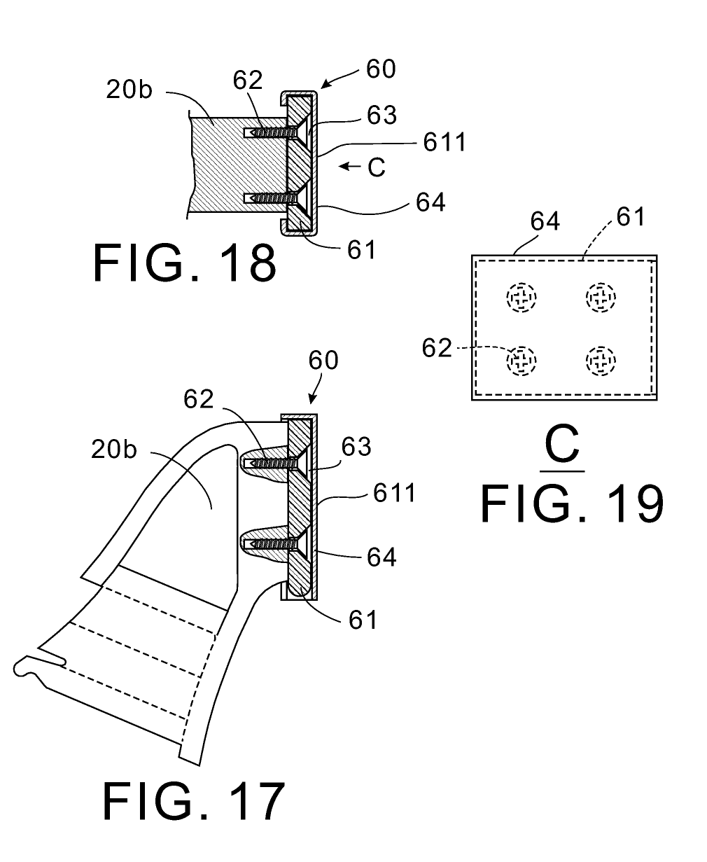

Referring to FIGS. 17 to 19, one of a pair of jaws 60 according to a third preferred embodiment of the invention is shown. The jaw 60, for example formed on the moveable jaw carrier 20b, comprises a rectangular resilient member 61 which is secured to the moveable jaw carrier 20b by screws 62, and a rectangular metal piece 64 fastened on the resilient member 61. A gap 63 is formed between each screw 62 and the clamping surface 611 of the metal piece 64. The other jaw 60 is identical to the jaw 60 described above except being formed on the fixed jaw carrier.

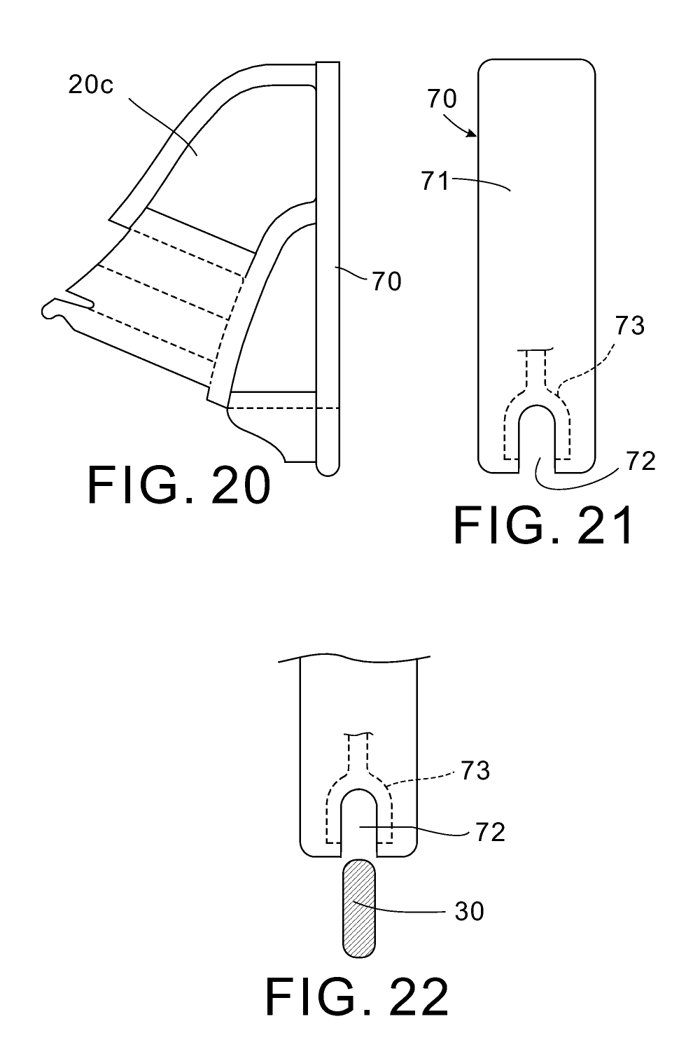

Referring to FIGS. 20 to 22, one of a pair of jaws 70 according to a fourth preferred embodiment of the invention is shown. The jaw 70, for example formed on the moveable jaw carrier 20c, comprises a rectangular member 71, a bottom slot 72, and a reinforced bifurcation 73 adjacent the slot 72 as support. The other jaw 70 is identical to the jaw 70 described above except being formed on the fixed jaw carrier.

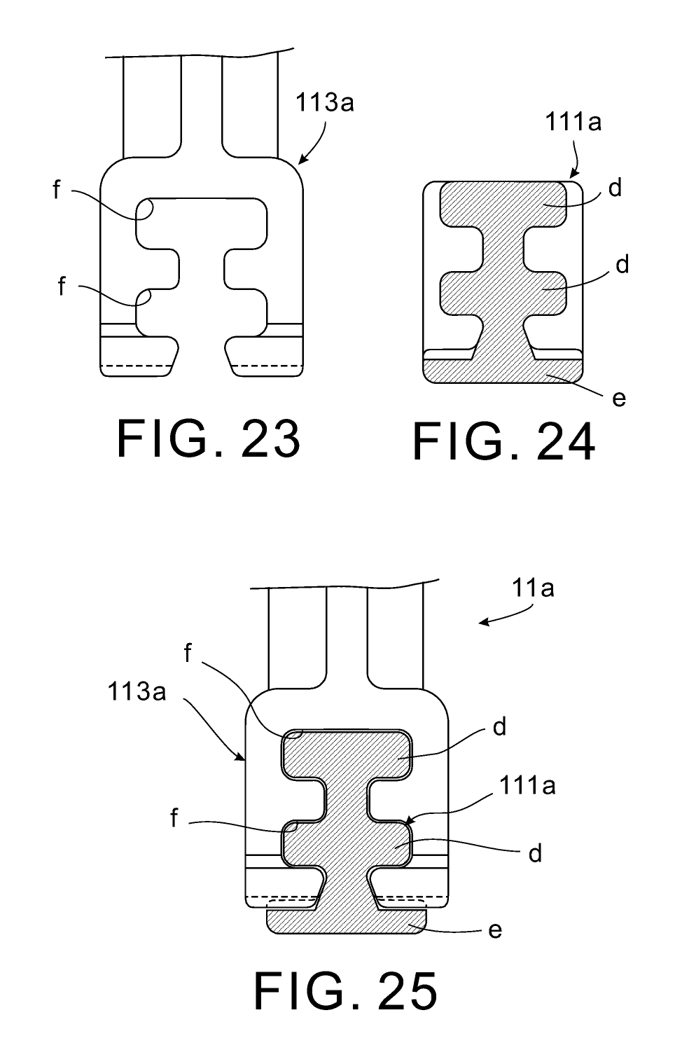

Referring to FIGS. 23 to 25, either coupling section according to another preferred embodiment thereof is shown. For example, the upper portion of the coupling section 11 comprises an upper groove 113a and the lower portion thereof comprises an upper projection 111a. The lower and upper portions are matingly coupled together to secure the coupling section 11 and the housing together. The other coupling section is a mirror image of the coupling section 11 describe above. Therefore a detailed description is deemed unnecessary.

It is envisaged that the jaw carriers of the bar clamp can be replaced when they are damaged. Further, the highly adaptable jaws can clamp one of work pieces of different shapes.

While the invention herein disclosed has been described by means of specific embodiments, numerous modifications and variations could be made thereto by those skilled in the art without departing from the scope and spirit of the invention set forth in the claims.

What is claimed is:

1. A bar clamp comprising:
a slide bar;
a housing mounted on the slide bar;
a rear handgrip extending from the housing;
a forward trigger handle extending from the housing,
a sliding block releasably mounted on the slide bar in front of the housing;
a fixed jaw carrier comprising an adaptable first jaw at one end;
a moveable jaw carrier comprising an adaptable second jaw at one end;
a first coupling mechanism for releasably securing the fixed jaw carrier to the housing; and
a second coupling mechanism for releasably securing the moveable jaw carrier to the sliding block.

2. The bar clamp of claim 1, wherein the first coupling mechanism comprises a first mating unit formed on the housing and a first corresponding mating unit formed on the other end of the fixed jaw carrier, the first corresponding mating unit being operable to matingly secure to the first mating unit, and wherein the second coupling mechanism comprises a second mating unit formed on the sliding block and a second corresponding mating unit formed on the other end of the moveable jaw carrier, the second corresponding mating unit being operable to matingly secure to the second mating unit.

3. The bar clamp of claim 2, wherein the first corresponding mating unit comprises a first groove and a first projection, and wherein the first mating unit comprises a second projection operable to matingly secure to the first groove, and a second groove operable to matingly secure to the first projection.

4. The bar clamp of claim 2, wherein the second corresponding mating unit comprises a third groove and a third projection, and wherein the second mating unit comprises a fourth projection operable to matingly secure to the third groove, and a fourth groove operable to matingly secure to the third projection.

5. The bar clamp of claim 1, wherein each of the first and second jaws comprises a pivotal upper rectangular portion having a plurality of rectangular first teeth on a lower edge, and a pivotal lower rectangular portion having a plurality of rectangular second teeth on an upper edge, the second teeth being complementary to the first teeth and spaced therefrom by a predetermined distance.

6. The bar clamp of claim 1, wherein the second jaw comprises two splayed post shaped protrusions, and wherein the first jaw is shaped as a post so that three vertices of a triangle is formed by the second and first jaws.
